(19) United States
(12) Patent Application Publication
(10) Pub. No.: US 2022/0206788 A1
(43) Pub. Date: Jun. 30, 2022

(54) VERSION CONTROL METHOD FOR PROGRAM PROJECT AND ASSOCIATED ELECTRIC DEVICE

(71) Applicant: REALTEK SEMICONDUCTOR CORPORATION, HSINCHU (TW)

(72) Inventors: SHIHJAN WEI, HSINCHU (TW); CHENG-HAO LI, HSINCHU (TW); CHIEN-CHIANG HUANG, HSINCHU (TW)

(21) Appl. No.: 17/539,097

(22) Filed: Nov. 30, 2021

(30) Foreign Application Priority Data
Dec. 30, 2020 (TW) 109146947

(51) Int. Cl. G06F 8/71; G06F 8/34; G06F 8/75

(52) U.S. Cl. CPC G06F 8/71; G06F 8/75; G06F 8/34

(57) ABSTRACT

The present application provides an electronic device and a version control method thereof for comparing program code files of a program project in different versions. The method includes: reading a first manifest file of a first version and a second manifest file of a second version of the program project; and performing an analyzing main program on the first manifest file and the second manifest file to generate a comparison result, and displaying the comparison result on a display device.

### CROSS-REFERENCE TO RELATED APPLICATIONS

This application claims the benefits of priority of Patent Application No. 109146947, filed in Taiwan on Dec. 30, 2020, which is hereby incorporated herein by reference in its entirety.

### TECHNICAL FIELD

The present application relates to a version control method for a program project and an associated electronic device; in particular, to a method and associated electronic device capable of comparing a program project's program code files in different versions.

### BACKGROUND

Recently, many tasks rely on software programs to be completed quickly and correctly. However, as software programs become larger and more complex, the development involves many developers, and during the development period, different people will continue to produce different versions of the software programs. Besides, the software program evolves into many versions with slight or significant differences when faced with different customers' diverse needs. Therefore, it has become one of the most critical issues in this field to enable developers to quickly understand the differences between various software program versions.

### SUMMARY OF THE INVENTION

Some embodiments of the present disclosure provide a version control method configured to compare program code files of a program project in different versions. The method includes: reading a first manifest file of a first version and a second manifest file of a second version of the program project; and performing an analyzing main program on the first manifest file and the second manifest file to generate a comparison result, and displaying the comparison result on a display device.

Some embodiments of the present disclosure provide an electronic device configured to compare program code files of a program project in different versions. The electronic device includes a memory module, a processor, and a display. The memory module is configured to store manifest files of the program project with a plurality of versions. The processor is configured to read a first manifest file of a first version and a second manifest file of a second version, and perform an analyzing main program on the first manifest file and the second manifest file to generate a comparison result. The display is configured to display the comparison result.

The method and electronic device according to the present disclosure can be used to find the difference between the program project's program code files in different versions quickly. Compared to conventional techniques, the present disclosure can increase the efficiency in modifying the program project and reduce the cost in terms of time.

### BRIEF DESCRIPTION OF THE DRAWINGS

FIG. 1 is a schematic diagram illustrating an electronic device according to some embodiments of the present disclosure.

FIG. 2 is a flow chart illustrating a method for comparing the difference between different versions of a program project according to some embodiments of the present disclosure.

FIG. 3 is a flow chart illustrating the details of a method for comparing the difference between different versions of a program project according to some embodiments of the present disclosure.

FIG. 4 is a flow chart illustrating a method for comparing the difference between different versions of a program project according to some other embodiments of the present disclosure.

### DETAILED DESCRIPTION

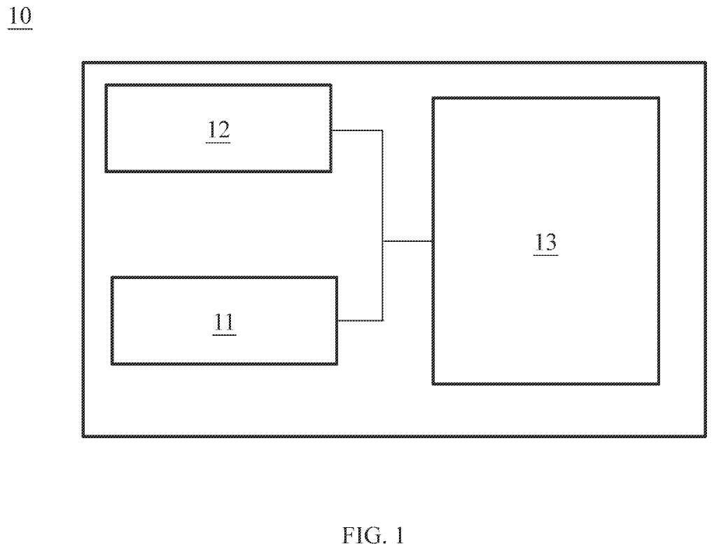

Reference is made to FIG. 1. FIG. 1 is a schematic diagram illustrating an electronic device 10 according to some embodiments of the present disclosure. The electronic device 10 is configured to create a program project, e.g., a program project for use in a television (TV) product. When the program project is to be used in two TV products of different specifications, the electronic device 10 (e.g., a computer) is configured to update the program project to generate different branches of the program project, so that TW products of different specifications can use the program project updated in response to its specification. After the program project is updated, the electronic device 10 is configured to record the update process, including addition, removal, and/or modification, and record the update process as a manifest file of a version. In other words, whenever the program project is updated, a new version will be generated, whereas the manifest file generated accompanying the update records the change history of the version.

In some embodiments, the manifest file is an extensible markup language (XML) file; however, the present disclosure is not limited thereto. All suitable file formats fall within the consideration and scope of the present disclosure.

The program project includes a plurality of program code files, and these program code files are respectively recorded by a plurality of tags in the manifest file. In some embodiments, tags are configured to record a name, a location, and a group of the program code files. In some embodiments, after the program project in a first version is updated to a second version, the electronic device 10 records a manifest file of the second version according to the update process. During the update process, at least a portion of the program code file is removed and/or modified, or additional program code files may be added to the program project; hence, the tags in the manifest file record the added program code file(s), modified program code file(s) and/or removed program code file(s).

Therefore, when a user wants to know the information that the program project's program code files change in different versions, the user can read the manifest files using the electronic device 10, and perform an analyzing main program on the manifest files to compare the difference between manifest files. After the electronic device 10 performs the analyzing main program, the electronic device 10 can generate a comparison result and display the same to the user for viewing.

With the advancements of the program project version, one program project can own many versions. The difference between versions of the program project is the information that a developer has to know before updating the program project. In conventional arts, when the user wants to compare the difference between versions of the program project because the project usually contains a large number of program code files, it takes a lot of time to compare the program code files of different versions one by one, which is prone to errors and is too costly in terms of time.

Compared to conventional arts, the electronic device 10 of the present disclosure employs a more efficient method for program project version control, which can quickly compare different versions of the program project and display the comparison results to the user. The user can use this comparison result to update the program project to generate another new version of the program project. This increases the efficiency of updating the program project and reduces the chance of comparison errors.

As shown in FIG. 1, the electronic device 10 includes a processor 11, a memory module 12, and a display 13. The processor 11 is coupled to the memory module 12 and the display 13. The processor 11 is configured to perform an analyzing main program, the memory module 12 is configured to store a manifest file, and the display 13 is configured to display a comparison result.

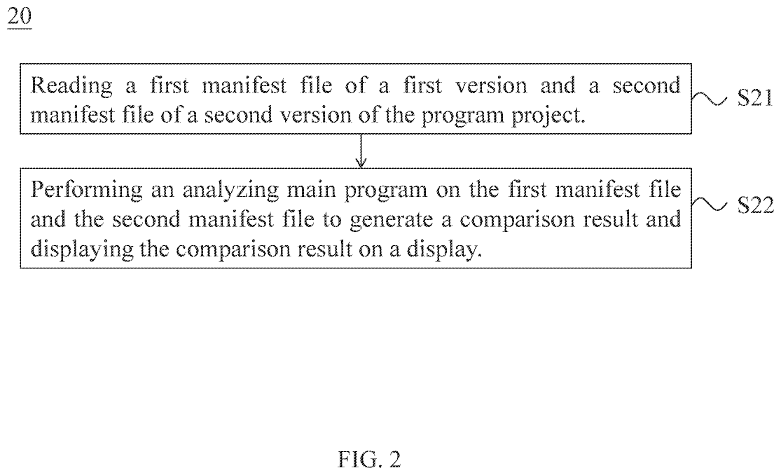

Reference is also made to FIG. 2. FIG. 2 is a flow chart illustrating a method 20 that the user uses to control the electronic device 10 to perform the comparison on the difference between the different versions of the program project. In some embodiments, the user can use the electronic device 10 to compare two versions of the program project, and classify a plurality of program code files in the program project according to manifest files of different versions and output the classification result as a comparison result. It is noted that the electronic device 10 can also be used to compare multiple versions of the program project; in the following discussion, the comparison of two versions is used as an example; however, the present disclosure is not limited thereto.

In Step S21, the processor 11 first read the program project's first manifest file in a first version and second manifest file in a second version from the memory module 12. Next, in Step S22, the processor 11 performs an analyzing main program on the first manifest file and the second manifest file that it reads to generate a comparison result and displays the comparison result on the display 13.

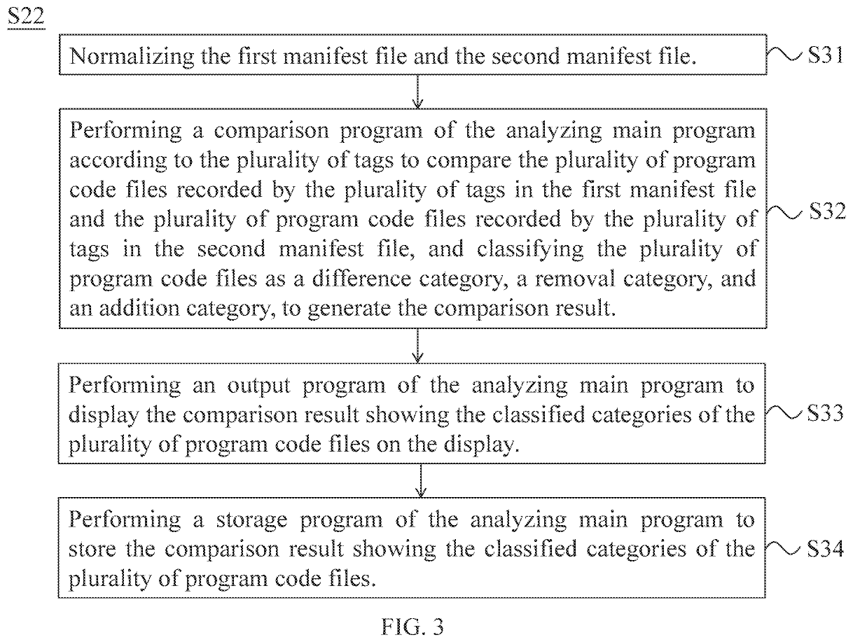

Reference is also made to FIG. 3. FIG. 3 is a flow chart illustrating the details of Step S22. As shown in FIG. 3, the Step S22 that the processor 11 performs the analyzing main program includes Steps S31, S32, S33, and S34. In Step S31, the processor 11 first normalizes the first manifest file and the second manifest file. Because the program project includes a large amount of program code files, the processor 11 first processes (e.g., sorts) the contents of the manifest files so that the processor 11 can perform the analyzing main program more easily in subsequent steps.

In Step S32, the processor 11 performs a comparison program of the analyzing main program according to the tags in the first manifest file and the second manifest file. The processor 11 respectively compares the program code files recorded in the tags of the first manifest file and the second manifest file and classifies the program code files as a difference category, a removal category, and an addition category.

For example, the program project includes a first program code file, a second program code file, and a third program code file in the first version, and includes a second program code file, a third program code file, and a fourth program code file in the second version. In this case, the second program code file in the first version is identical to the second program code file in the second version (i.e., the second program code file is not modified from the first version to the second version), and the third program code file of the first version is different from the third program code file of the second version (that is, the third program code file has been modified from the first version to the second version). In this example, the processor 11 can make the following classification for the above-mentioned program code files: because the second version, compared to the first version, no longer includes the first program code file, the first program code file is classified as the removal category; because the second program code file remains unchanged, it does not belong to any of the three categories; because the third program code file of the second version, compared with that of the first version, has been modified, the third program code file is classified as the difference category; and because the second version, compared to the first version, has an additional fourth program code file, the fourth program code file is classified as the addition category.

In other words, when the program code file recorded by the plurality of tags in the first manifest file differs from the program code file recorded by the plurality of tags of the second manifest file, it is classified as the difference category. When the program code file recorded by the plurality of tags in the first manifest file fails to exist in the program code file recorded by the plurality of tags of the second manifest file, it is classified as the removal category. When the program code file recorded by the plurality of tags of the second manifest file fails to exist in the program code file recorded by the plurality of tags in the first manifest file, it is classified as the addition category.

In Step S33, the processor 11 generates a comparison result containing the information of the classified categories (e.g., the difference category, the removal category, and the addition category) and outputs the comparison result to the display 13 for display. In some embodiments, the processor 11 display the comparison result using an object of tables, e.g., using the worksheet of Microsoft Excel.

In some embodiments, the user can identify the program project's program code files that are respectively classified as the difference category, the removal category, and the addition category from the displayed comparison result, thereby identify possible reasons that causes the difference in the execution results between the first version and the second version.

In Step S34, the processor 11 stores the comparison result in the memory module 12. For example, it stores the above-mentioned worksheet in the memory module 12.

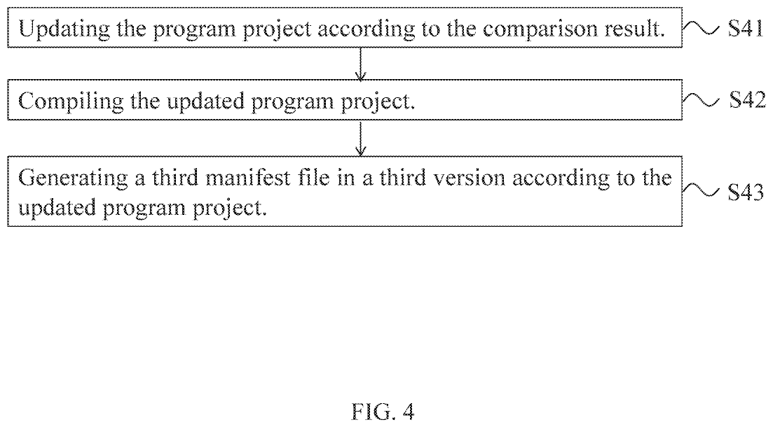

In some other embodiments, the method 20 further includes Steps S41, S42, and S43 shown in FIG. 4. The user can check the bugs exist in the program project using the method 20 and update the program project according to the comparison result generated in Step S22. For example, the program project's second version is obtained by updating the program project's first version; however, when performing the program project's second version, the user finds that the program project executing the second version obtains an unexpected result different from the program project executing the first version. Therefore, in order to address the bugs possibly existing in the second version, the user can first obtain the comparison result by performing the method 20 and then performs Steps S41, S42, and S43, so as to fix the bugs in the program project's second version.

As shown in FIG. 4, in Step S41, the user updates the program project to generate the program project's third version according to the comparison result generated in Step S22. Next, in Step S42, the user compiles the program project's third version using the processor 11. Lastly, in Step S43, the user generates the third manifest file of the third version using the processor 11 according to the updated program project. In other word, in Steps S41-S43, the user updates the program code file of the program project according to the comparison result (e.g., the foregoing modification, addition and/or removal), and record the update process in the third manifest file by using the processor 11.

In some embodiments, after obtaining the comparison result, the user can make the update according to the program code files that are classified as differential, removal and/or addition, so as to find the reasons causing the difference between the execution results of the first version and the second version. After the program project is updated, the processor 11 compiles the updated program project. In further embodiments, the processor 11 performs the compiled program project to check whether the execution result meets the expectation.

Besides, after the program project is updated, the program project in a new version (i.e., the above-mentioned third version) is generated. Therefore, in order to control the version changes in the program project, the processor 11 generates a third manifest file according to the updated program project and stores the third manifest file in the memory module 12.

What is claimed is:

1. A version control method, configured to compare a plurality of program code files of a program project in different versions, comprising:
reading a first manifest file of a first version and a second manifest file of a second version of the program project; and
performing an analyzing main program on the first manifest file and the second manifest file to generate a comparison result and displaying the comparison result on a display.

2. The version control method of claim 1, wherein the first manifest file and the second manifest file are extensible markup language (XML) files.

3. The version control method of claim 1, wherein each of the first manifest file and the second manifest file includes a plurality of tags respectively configured to record the plurality of program code files.

4. The version control method of claim 3, wherein the plurality of tags are configured to record a name, a location and a group of the plurality of program code files.

5. The version control method of claim 3, wherein the step of performing the analyzing main program on the first manifest file and the second manifest file to generate the comparison result comprises:
normalizing the first manifest file and the second manifest file.

6. The version control method of claim 3, wherein the step of performing the analyzing main program on the first manifest file and the second manifest file to generate the comparison result comprises:
performing a comparison program of the analyzing main program according to the plurality of tags to compare the plurality of program code files recorded by the plurality of tags in the first manifest file and the plurality of program code files recorded by the plurality of tags in the second manifest file, and classifying the plurality of program code files as a difference category, a removal category, and an addition category, to generate the comparison result.

7. The version control method of claim 6, wherein:
when the plurality of program code files recorded by the plurality of tags in the first manifest file differ from the plurality of program code files recorded by the plurality of tags in the second manifest file, classifying the plurality of program code files as the difference category,
when the plurality of program code files recorded by the plurality of tags in the first manifest file fail to exist in the plurality of program code files recorded by the plurality of tags in the second manifest file, classifying the plurality of program code files as the removal category, and
when the plurality of program code files recorded by the plurality of tags in the second manifest file fail to exist in the plurality of program code files recorded by the plurality of tags in the first manifest file, classifying the plurality of program code files as the addition category.

8. The version control method of claim 6, wherein the step of performing the analyzing main program on the first manifest file and the second manifest file to generate the comparison result further comprises:
performing an output program of the analyzing main program to display the comparison result showing the classified categories of the plurality of program code files on the display.

9. The version control method of claim 6, wherein the step of performing the analyzing main program on the first manifest file and the second manifest file to generate the comparison result further comprises:
performing a storage program of the analyzing main program to store the comparison result showing the classified categories of the plurality of program code files.

10. The version control method of claim 1, further comprising:
updating the program project according to the comparison result;
compiling the updated program project; and
generating a third manifest file in a third version according to the updated program project.

11. An electronic device, configured to compare a plurality of program code files of a program project in different versions, comprising:
a memory module, configured to store manifest files of the program project with a plurality of versions;
a processor, configured to read a first manifest file of a first version and a second manifest file of a second version, and perform an analyzing main program on the first manifest file and the second manifest file to generate a comparison result; and
a display, configured to display the comparison result.

12. The electronic device of claim 11, wherein the comparison result is used as a basis to update and compile the program project to generate third manifest file of the program project in a third version of.

13. The electronic device of claim 11, wherein, the plurality of manifest files are extensible markup language (XML) files.

14. The electronic device of claim 11, wherein each of the first manifest file and the second manifest file includes a plurality of tags respectively configured to record the plurality of program code files.

15. The electronic device of claim 14, wherein the plurality of tags are configured to record a name, a location and a group of the plurality of program code files.

16. The electronic device of claim 14, wherein the processor is further configured to perform the analyzing main program to normalize the first manifest file and the second manifest file.

17. The electronic device of claim 14, wherein the processor is further configured to perform the analyzing main program to compare the plurality of program code files recorded by the plurality of tags in the first manifest file and the plurality of program code files recorded by the plurality of tags in the second manifest file, and to classify the plurality of program code files as a difference category, a removal category, and an addition category.

18. The electronic device of claim 17, wherein:
when the plurality of program code files recorded by the plurality of tags in the first manifest file differ from the plurality of program code files recorded by the plurality of tags in the second manifest file, the plurality of program code files are classified as the difference category,
when the plurality of program code files recorded by the plurality of tags in the first manifest file fail to exist in the plurality of program code files recorded by the plurality of tags in the second manifest file, the plurality of program code files are classified as the removal category, and
when the plurality of program code files recorded by the plurality of tags in the second manifest file fail to exist in the plurality of program code files recorded by the plurality of tags in the first manifest file, the plurality of program code files are classified as the addition category.

19. The electronic device of claim 17, wherein the processor is further configured to perform the analyzing main program to display the classified difference category, removal category, and addition category on the display as the comparison result.

20. The electronic device of claim 17, wherein the processor is further configured to perform the analyzing main program to store the comparison result as a comparison result file in the memory module.
